(19) United States
(12) Patent Application Publication
(10) Pub. No.: US 2007/0266833 A1
(43) Pub. Date: Nov. 22, 2007

(54) Method and Mechanism for Increasing Critical Speed in Rotating Disks and Reducing Kerf at High Speeds in Saw Blades

(75) Inventors: Peter Radziszewski, Baie D'Urfe (CA); Julien Poirier, Campbell River (CA)

Correspondence Address: GOUDREAU GAGE DUBUC, 2000 MCGILL COLLEGE, SUITE 2200, MONTREAL, QC, H3A 3H3, CA

(73) Assignee: McGILL UNIVERSITY, Montreal, QC (CA)

(21) Appl. No.: 11/568,899

(22) PCT Filed: May 12, 2005
(86) PCT No.: PCT/CA25/00729

§ 371 Date: Jun. 6, 2007

Related U.S. Application Data
(60) Provisional application No. 60/570,079, filed on May 12, 2004.

(51) Int. Cl. B27G 19/02; B27B 33/08

(52) U.S. Cl. 83/13; 83/835

(57) ABSTRACT

There is provided a method for increasing the critical speed of a rotating disk and disk using same. The method comprises the steps of providing a disk and fastening at least one heat sensitive insert to the disk. The insert exerts a tensile stress on the disk when an insert temperature exceeds a predetermined temperature. The disk could be a saw blade. Also, there is provided a saw blade and method having a reduced kerf at high speeds, the blade having a serrated cutting edge. The blade comprises at least one insert attached to the blade, the at least one insert exerting a tensile stress on the blade when an insert temperature reaches a predetermined temperature, the exerted tensile stresses opposite to those induced by the blade temperature.

### BACKGROUND OF THE INVENTION

In the production of lumber, appreciable amounts of timber are converted into sawdust by the saw blade. As most saw dust is waste and is subsequently discarded into landfills or incinerated, reduction in the amount of sawdust provides for an improved usage of the timber. Additionally, trends such as environmental constraints on timber harvesting, smaller logs and an increased demand for wood products have driven the lumber industry to seek new ways to improve the efficiency of their production processes.

The amount of sawdust is determined by the width of the cut, or kerf, made by the teeth of the saw blade in the timber. Typical circular sawmill converts 50% of a log into primary lumber with the recovery rate of band mills being somewhat higher at about 57%. Losses due to saw kerf average about 20% for a circular sawmill and as low as 12% for high production band mills.

The saw kerf has a significant impact on the efficiency of the conversion of timber to lumber. One way of calculating the amount of sawdust that develops during sawing is to determine the total wood usage per “pass” (as logs being processed by a sawmill generally move or “pass” back and forth through the saw blade). Wood usage per pass includes the average thickness of the piece being sawn plus the saw kerf. For example, in sawing a plank that is 20 mm thick with a saw having a kerf of 5 mm, the total wood usage per pass is 25 mm. Calculating the saw kerf as a percentage of the total wood usage per pass results in 20% of the wood removed as sawdust or approximately one-fifth of the timber resource.

With circular saws, which given their limited size are used primarily in sawmill operations directed at small logs, the thickness of the saw blade is determined not only by blade thickness but also to a large degree by the stability of the blade when rotated at high speed. When rotated at speeds closing in on the critical speed, the saw blade becomes unstable, leading to large transverse deflections and even blade failure. These deflections lead to increased kerf as well as a rougher cut, further increasing the amount of material that must be removed to provide high grade lumber. Additionally, friction between the blade and timber causes the temperature at the periphery of the saw blade to increase, which in turn causes a temperature gradient to be set up from the inside to the outside of the blade, thereby lowering the blade's critical speed.

As saws with thinner blades are typically more unstable than thicker blades, the speed at which the thinner blades can be operated can be significantly lower than that of the thicker blades. This leads to a reduction in the speed at which timber can be sawn by the blade and the performance of the sawmill.

In an attempt to overcome these disadvantages the prior art discloses circular saw blades on which reinforcing guides have been installed to damp transverse displacements. The prior art also discloses stiffening the saw blade using pre-tensioning whereby stresses are introduced into the blade through plastic deformation. Other methods include heating the blade at its centre, decreasing the temperature gradient and to some degree its adverse effect on critical speed.

### SUMMARY OF THE INVENTION

In order to overcome the above and other disadvantages, there is provided a method for increasing the critical speed of a rotating disk. The method comprises the steps of providing a disk and fastening at least one heat sensitive insert to the disk. The at least one insert exerts a tensile stress on the disk when an insert temperature exceeds a predetermined temperature.

There is also provided a disk having an increased critical speed of rotation. The disk comprises at least one temperature sensitive insert fastened to the disk, the at least one insert exerting a tensile stress on the disk when a temperature of the at least one insert exceeds a predetermined temperature.

Furthermore, there is provided a disk having an increased critical speed of rotation. The disk comprises a plurality of spaced slits machined in a periphery of the disk, each of the slits comprising a pair of opposed slit edges extending from the disk periphery towards a disk axis of rotation, and for each of the slits, a temperature sensitive insert fastened to the disk and spanning the slit. When an insert temperature exceeds a predetermined temperature, the insert contracts thereby reducing a distance between the pair of opposed slit edges.

Additionally, there is provided a method for reducing the kerf of a saw blade at high speeds, the blade having a serrated edge and a blade temperature which varies in relation to the distance from the serrated edge. The method comprises the steps of providing a blade, and attaching at least one insert to the blade, the at least one insert exerting a tensile stress on the blade when a temperature of the at least one insert reaches a predetermined temperature, the exerted tensile stress opposite to a tensile stress induced in the blade by the varying blade temperature.

Also, there is provided a saw blade having a reduced kerf at high speeds, the blade having a serrated cutting edge. The blade comprises at least one insert attached to the blade, the at least one insert exerting a tensile stress on the blade when an insert temperature reaches a predetermined temperature, the exerted tensile stress opposite to stress induced by the blade temperature.

### BRIEF DESCRIPTION OF THE DRAWINGS

FIG. 1 is a side plan view of a saw blade in accordance with an illustrative embodiment of the present invention;

FIG. 2 is a side view of a saw blade and work piece in accordance with an illustrative embodiment of the present invention;

FIG. 3 is a graph detailing the temperature gradient induced in a saw blade in contact with a work piece in accordance with an illustrative embodiment of the present invention;

FIG. 4 provides examples of modes of vibrations which arise in a disk;

FIG. 5 is a sectional view along line 5-5 in FIG. 1;

FIG. 6A is a side view of a portion of a disk/blade with an insert installed in accordance with an alternative illustrative embodiment of the present invention;

FIG. 6B is a sectional view along line 6B-6B in FIG. 6A;

FIG. 7A is a side view of a portion of a disk/blade with inserts installed in accordance with a second alternative illustrative embodiment of the present invention;

FIG. 7B is a sectional view along line 7B-7B in FIG. 7A;

FIG. 8A is a side view of a disk/blade with inserts installed in accordance with a third alternative illustrative embodiment of the present invention;

FIG. 8B is a sectional view along line 8B-8B in FIG. 8A;

FIG. 9A is a side view of a disk/blade with insert(s) installed in accordance with a forth alternative illustrative embodiment of the present invention;

FIG. 9B is a sectional view along line 9B-9B in FIG. 9A;

FIG. 10 is a side view of a disk/blade with insert(s) installed in accordance with a fifth alternative illustrative embodiment of the present invention; and

FIG. 11 is a side plan view of a saw blade in accordance with a sixth alternative illustrative embodiment of the present invention.

### DETAILED DESCRIPTION OF THE ILLUSTRATIVE EMBODIMENTS

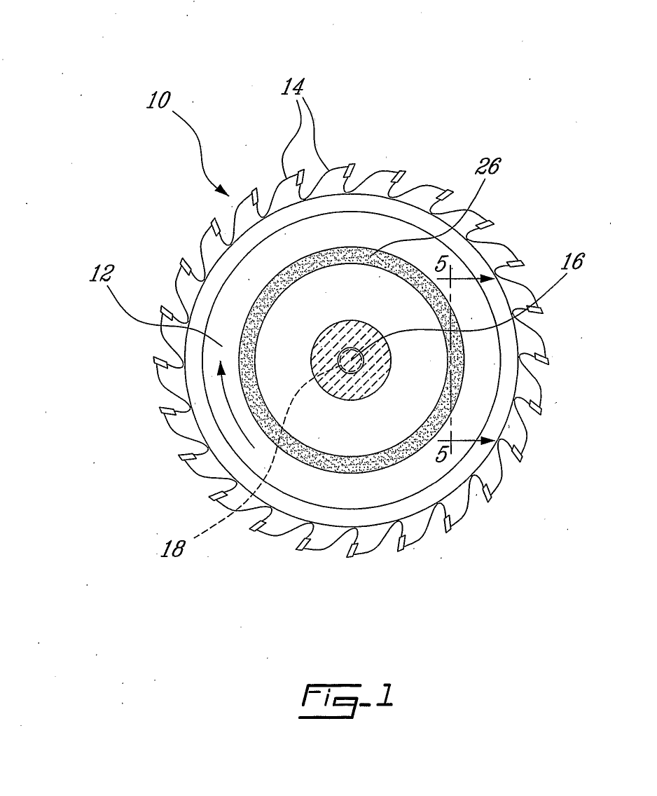

Referring now to FIG. 1, a saw blade, generally referred to using the reference numeral 10 and in accordance with an illustrative embodiment of the present invention will now be described. The saw blade 10 comprises a disk portion 12 with a plurality of teeth (or serrated edge) as in 14 arranged around the disk portion 12. A hole (not visible) is machined through the centre 16 of the blade 10 for mounting the blade on a shaft 18. The shaft 18 is in turn driven by a turbine (not shown) or other source of rotary power. The saw blade 10 is typically manufactured from a ferrous metal such as high speed steel (HSS) or the like. In many cases the saw teeth 14 are heat treated to increase their hardness and/or tipped with tungsten carbide thus improving wear.

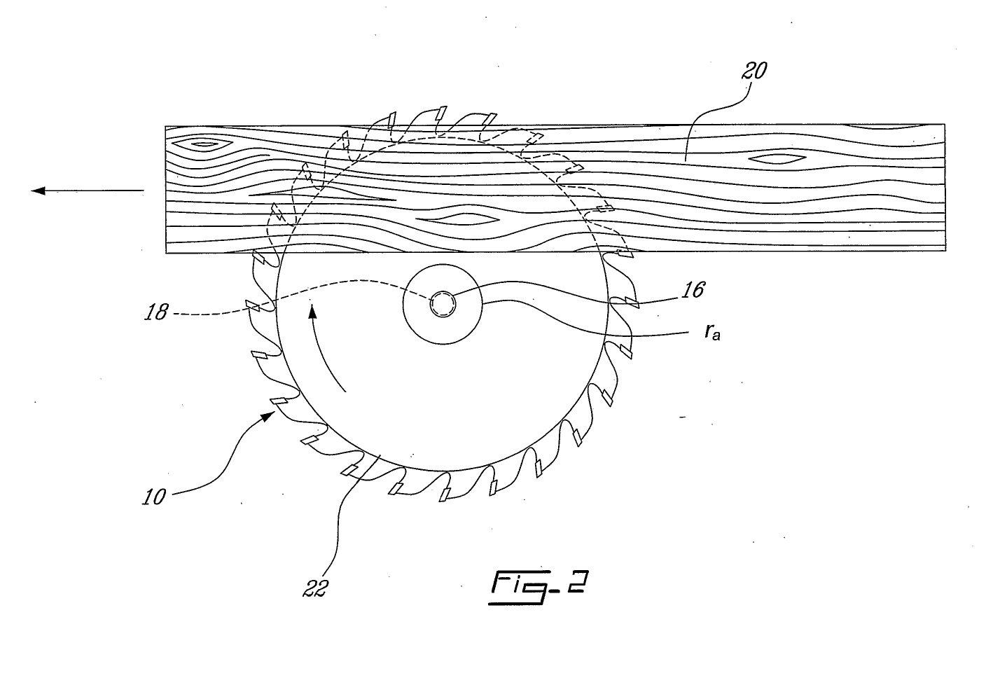

Referring now to FIG. 2, as stated above friction between the blade 10 and work piece 20 as the work piece 20 is driven into the path of the blade 10 causes a temperature gradient to be set up from the blade's centre 16 to it's periphery 22. Referring to the graph of FIG. 3 superimposed upon the saw blade 10, the temperature T, indicated by the dashed line 24, increases gradually as a function of the distance R from the blade's centre 16 towards the periphery 22, but drops off thereafter as convection of air brings about a greater cooling effect. Additionally, the interaction between fresh lumber (not shown) meeting the teeth as in 14 as well as the ejected sawdust (not shown) also serve to cool the blade 10 to some degree by conduction.

Still referring to FIG. 2, two membrane stresses are brought to bear on the saw blade 10 when cutting the work piece 20: rotational stress and thermal stress. Additionally, a third membrane stress, pretensioning stress, can be introduced by plastic deformation of the blade 10 during manufacturing.

Rotation of the disk/blade 10 introduces both radial and hoop tensile membrane stresses into the disk/blade.

Thermal stress of the disk/saw blade 10 is a function of the coefficient of expansion of the material used to manufacture the blade and the heat generated by cutting, wherein the heat generated by cutting varies as a function of the friction between the teeth (14 in FIG. 1) and the work piece 20. Although these stresses increase when the temperature of the blade increases uniformly, when heating occurs only at the periphery 22 of the blade 10, the blade 10 does not expand in a radial direction but rather compresses in the hoop direction, which leads to an increase in the hoop stresses, increased instability of the blade 10 and a lowering of the critical speed of the blade 10. As a result it is foreseen that the present invention will provide the greatest improvements in stability with blades 10 (and other disks) where the temperature throughout the blade 10 is not uniform.

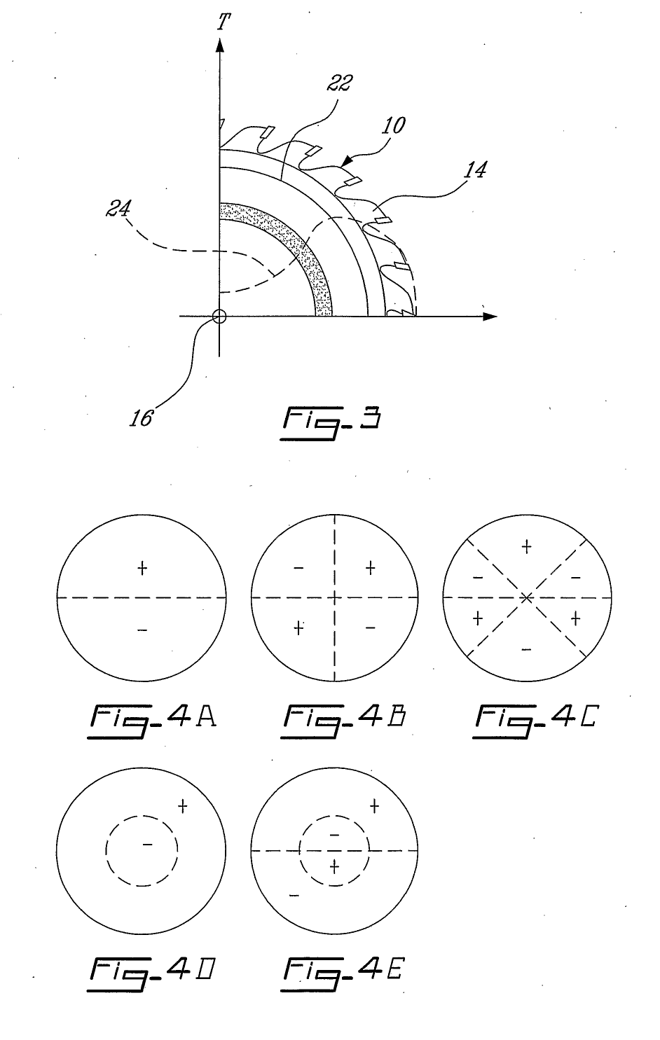

Referring now to FIGS. 4A though E, vibrations arise in a circular disk along nodes arranged along the disk's diameters (FIGS. 4A, 4B and 4C) and circles (FIGS. 4D and 4E). For a given frequency of vibration, the number of diameters or circles along which the vibrations are arranged provides the mode of the vibration. Vibrations having the greatest effect are those of low mode (i.e. no nodal circles and a single nodal diameters). As the membrane stresses in the disk change, so do the frequencies of vibrations. As would be expected, disks where the ratio of diameter to width on a disk is large exhibit greater susceptibility to the effects of membrane stresses.

Vibrations on a disk are comprised of forward and backward travelling waves which travel in a circular fashion around the disk. From the standpoint of an observer on the disk, the waves travel at the same velocity. However, when a disk is spinning, the rotation causes the speed of the wave travelling counter to the direction of rotation to be reduced and the one travelling in the direction of rotation to be increased (as observed by a stationary observer). As a result, any increase in the angular velocity will cause a corresponding increase in one of the travelling waves and decrease in the other. As the speed of rotation is increased to the critical speed, the speed of one of the travelling waves eventually drops to zero, and to a stationary observer will appear as a standing wave. The presence of a standing wave has a similar effect as resonant frequency and in many cases is the cause of failure of a spinning disk.

The critical speed, therefore, is equal to the fundamental frequency of vibration divided by the number of modal diameters. At this speed, a standing wave develops and causes resonance, which leads to instability and an increased likelihood of disk failure. As a result, the speed of operation of many machines, such as turbines and, as in the case at hand, saw mill equipment, are limited to a large degree by this critical speed. Indeed, the majority of such equipment is operated at a maximum of about 85% of this critical speed. In saw mills, as the critical speed varies directly relative to the thickness of the saw blade, in order to operate at higher speeds the thickness of the blade must be increased which increases the kerf, leading to a reduction in conversion efficiency.

Referring back to FIG. 2, spinning has the effect of raising the fundamental frequency of vibration (and therefore of all modes) due to the introduction of rotational stresses (as discussed hereinabove). As the saw blade 10 spins, radial and hoop stresses are increased in the region rₐ where the blade 10 is clamped to the shaft 18. However, at the periphery 22 of the saw blade 10 the rotational stresses are reduced to zero. When the temperature of the periphery 22 is increased, the hoop stresses become compressive while there is little impact on the radial stresses. The increase in compressive hoop stress at the periphery 22 results in a decrease of modal frequencies of the two-diameter and greater modes. The effect is most pronounced at the two (2) and three (3) diameter modes.

As a result, critical speed and stability play a large part in an increased kerf size. As stability increases at high speed with an increase in the fundamental frequency of vibration of the blade, the greater the fundamental frequency, the lower the kerf at high speeds.

Referring back to FIG. 1, in order to increase the fundamental frequency of the disk/blade 10, heat sensitive insert(s) as in 26 fabricated from a Shape Memory Alloy (SMA) are incorporated into the blade 10. As known in the art, SMAs are a class of metal alloys that can recover apparent permanent strains when they are heated above a certain temperature. The SMAs have two stable phases—the high-temperature phase, called austenite and the low-temperature phase, called martensite. A phase transformation which occurs between these two phases upon heating/cooling is the basis for the properties of the SMAs. The key effects of SMAs associated with the phase transformation are pseudoelasticity and shape memory effect. In the austenite phase, the alloy shows isotropic elasticity similar to that of other metallic materials. In the martensite phase the alloy is easily deformed, allowing for large deformations which are reversible when the alloy returns to the austenite phase. The martensite phase is capable of reversible strains with a range of approximately 3% to 8% at little or no stress. As discussed above, whether or not an SMA is in the austenite or martensite phase is dictated by the temperature of the alloy, the austenite phase being reached at higher temperatures than the martensite phase. As a result, as the temperature of an SMA increases, the SMA moves from the martensite to the austenite phase. In the austenite phase the SMA regains its original shape.

Of note, however, is that the temperature for onset of transformation from the martensite to austenite phase (T_{As}) is typically much higher than the temperature for onset of transformation from the austenite to the martensite phase (T_{Fs}). Additionally, complete transformation from the martensite to austenite phase will only be achieved if the temperature is increased beyond the temperature of transformation onset to a higher temperature of transformation completion (T_{Af}). A similar effect is seen when the alloys are cooled from the austenite to the martensite phases.

SMAs can be trained to have a specific shape in the austenite phase by heat treating at high temperatures (typically in excess of 600° C.) for a relatively short period of time. Once the SMA has been trained, it will regain this shape when transformed from the martensite to the austenite phase.

The temperature at which the martensite phase transforms into austenite phase is determined by the composition of the alloy. The martensite transformation temperature is also a function of the stresses applied to the alloy. As the applied stresses increase, the temperature of martensite transformation also increases. In high stress situations the material can become pseudoelastic, exhibiting properties similar to that of rubber.

Still referring to FIG. 1, the SMA inserts 26 are fabricated from a suitable SMA such as Nickle-Titanium (also known as NiTi or Nitinol). Other potential SMAs include copper based alloys such as CuZnAl and CuAlNi as well as iron based alloys. NiTi has a number of features which make it suitable for use in the present context, including a high shape memory effect over a high number of phase transition cycles and a significant contraction of the alloy in the austenite phase vis-à-vis the martensite phase. Variation of the alloying (for example, the Nickel to Titanium ratio in NiTi) and doping of the SMA provides control over the austenite transition onset temperature (T_{As}) and the austenite transition completion temperature (T_{Af}). For example, typical NiTi is comprised of 54.4% Nickel, the remainder Titanium. Increasing the amount of Nickel decreases the transformation temperature, typically by 10° C. for each 0.1% change in Nickel content. Other compounds can be used to dope the Nitinol, including: Iron, which produces a very low transformation temperature; Copper, which lowers the transformation temperature slightly; and Chromium, which lowers the transformation temperature to just below freezing.

The Nitinol alloy was doped to provide a T_{As} of 30° C. and a T_{Af} of 70° C. Additionally, the SMA inserts were heat treated to provide stresses when in transition from the martensite to austenite phase opposite to those induced in the blade by heat and rotation. Of note is that the rate of strain introduced by the SMA inserts 26 increases approximately linearly between T_{As} and T_{Af}.

To optimise the positioning of the SMA inserts 26, the temperature distribution of the blade 10 was analysed for a wide range of angular velocities to find regions on the blade 10 where austenite temperatures were present during normal operation. This was found to arise primarily in the outer fifth of the blade 10. As a result, the blade 10 was machined and the SMA inserts 26 were positioned in this region.

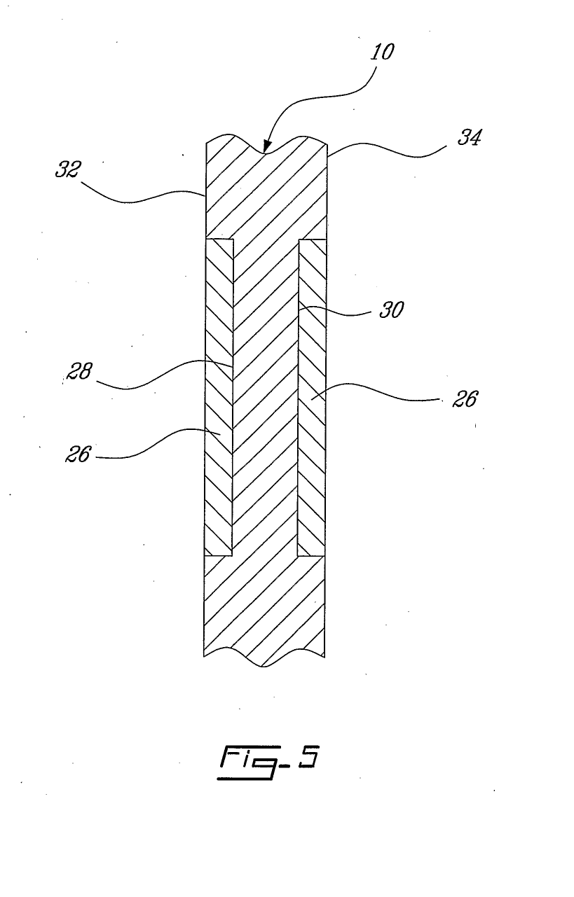

Referring now to FIG. 5, the inserts 26 were bonded to depressions 28, 30 machined in both surfaces 32, 34 of the blade 10. A number of techniques, including spraying, powder metallurgy, rivets, press fits, explosive bonding and (in some cases) welding are available which provide a suitably strong heat resistant bond between the SMA inserts 26 and the surfaces 32, 34 of the blade 10. In this regard, it is important that the bond is sufficient to prevent the inserts 26 from slipping or separating from the blade 10. As a result, in the region of the insert the blade 10 was comprised of three layers: a layer of steel sandwiched between two layers of SMA. Illustratively, inserts are bonded on both surfaces 32, 34 in order to provide for relatively equal stresses on both sides, which also reduces the risk of “cupping” of the disk/blade 10 during operation. In operation, the introduction of the SMA inserts 26 leads to a reduction in hoop stresses along the outer edge of the blade 10 by producing tensile stresses when heated above T_{As}. At higher temperatures (up to T_{Af} and beyond), the reduction in hoop stresses along the outer edge of the blade 10 is more pronounced. Additionally, as discussed above, an increase in temperature of the blade 10 leads to a decrease in the fundamental frequencies of vibration, in particular the two diameter frequency and its higher modes, which in turn leads to a decrease in the critical speed of the blade. Introduction of the SMA inserts 26 leads to a significant reduction in the effect of temperature on the critical speed, thereby allowing the blade 10 to be operated at higher speeds without increasing the kerf.

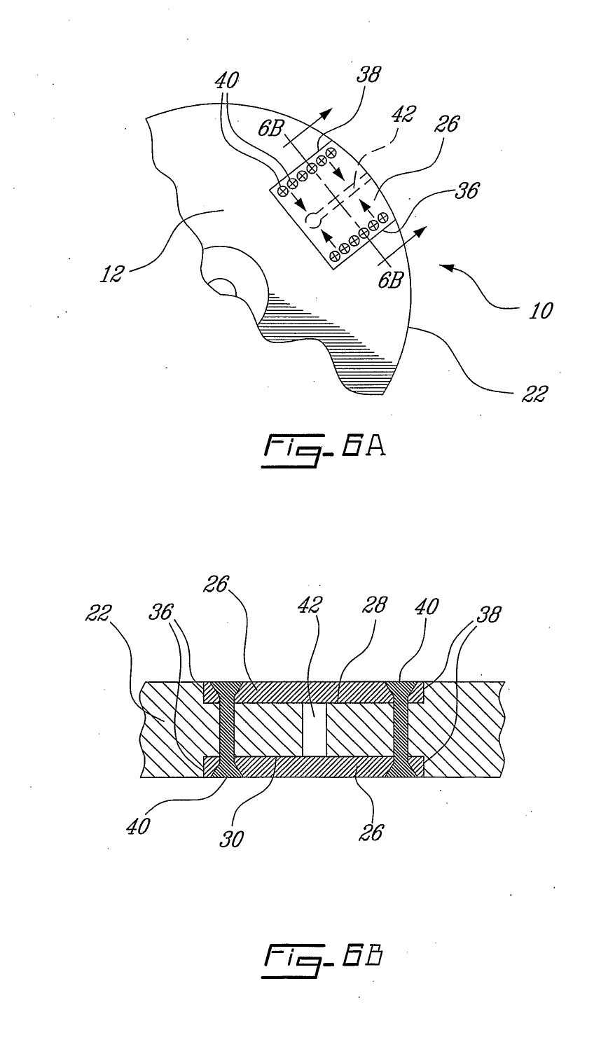

Referring now to FIGS. 6A and 6B, in a first embodiment, the inserts 26 and depressions 28, 30 are generally rectangular in shape. The inserts 26 are attached to the blade 10 towards the outer edges 36, 38 via a series of fasteners as in 40, for example rivets or screws or the like. The inserts 26 straddle a slit 42 in the blade 10, the slit 42 illustratively in a direction radial to the axis of rotation. The inserts 26 are heat treated such that when in the austenite phase the outer edges 36, 38 are brought closer together. Therefore, as the periphery 22 of the blade 10 is heated, forces are brought to bear on the blade between the fasteners as in 40 (in the direction indicated by the arrows) and the gap of the radial slit 42 is reduced, thereby reducing the hoop stresses introduced by the peripheral heating.

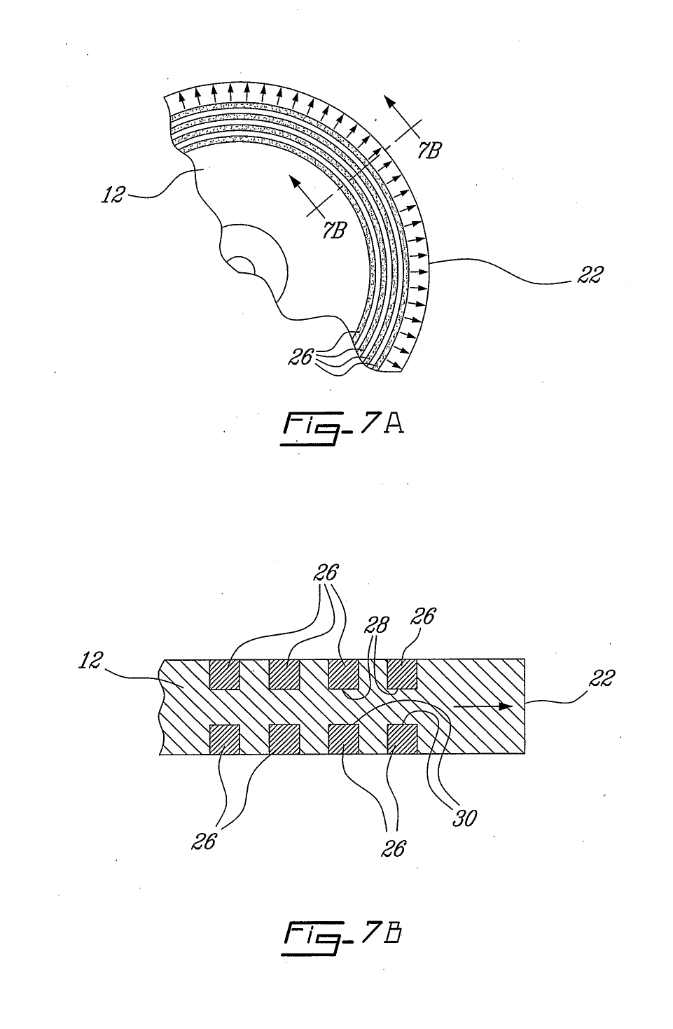

Referring now to FIGS. 7A and 7B, in a second embodiment, the inserts 26 and depressions as in 28, 30 are annular in shape. One or more inserts as in 26 are press fit into the annular depressions as in 28, 30. The inserts are heat treated such that when in the austenite phase they expand in a radial direction outward. Therefore, as the periphery 22 of the blade 10 is heated, forces in a outward radial direction (as indicated by the arrows arrange around the periphery 22) are introduced, thereby countering the hoop stresses introduced by the peripheral heating. Of note is that although the present invention has been discussed hereinabove in regards to blades or disks where the periphery has a higher temperature than centre of the blade or disk, the present invention may also be applied to increase the stability of uniformly heated blades or disks, or alternatively for pretensioning disks which operate at room or lower temperatures. For example, the insert(s) 26 as described hereinabove could be fabricated with an SMA having a T_{As} well below room temperature, for example −30° C. The SMA would be heat treated such that in the austenite phase, tensile stresses in the disk would be increased, thereby improving the stability of the disk at room temperature.

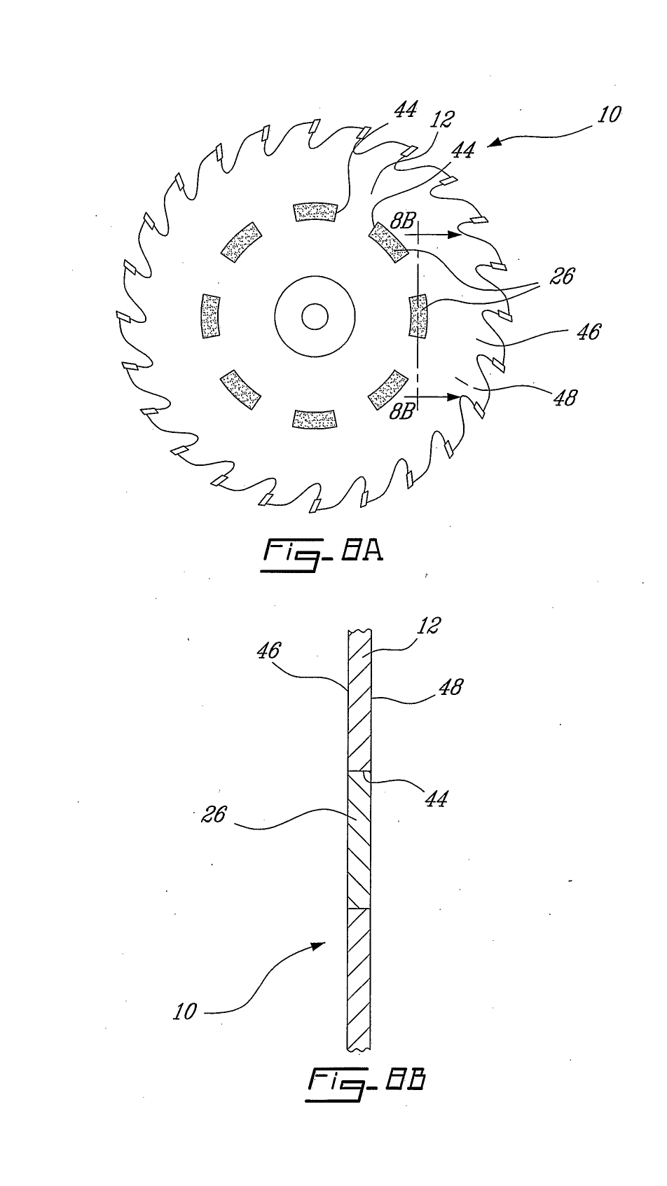

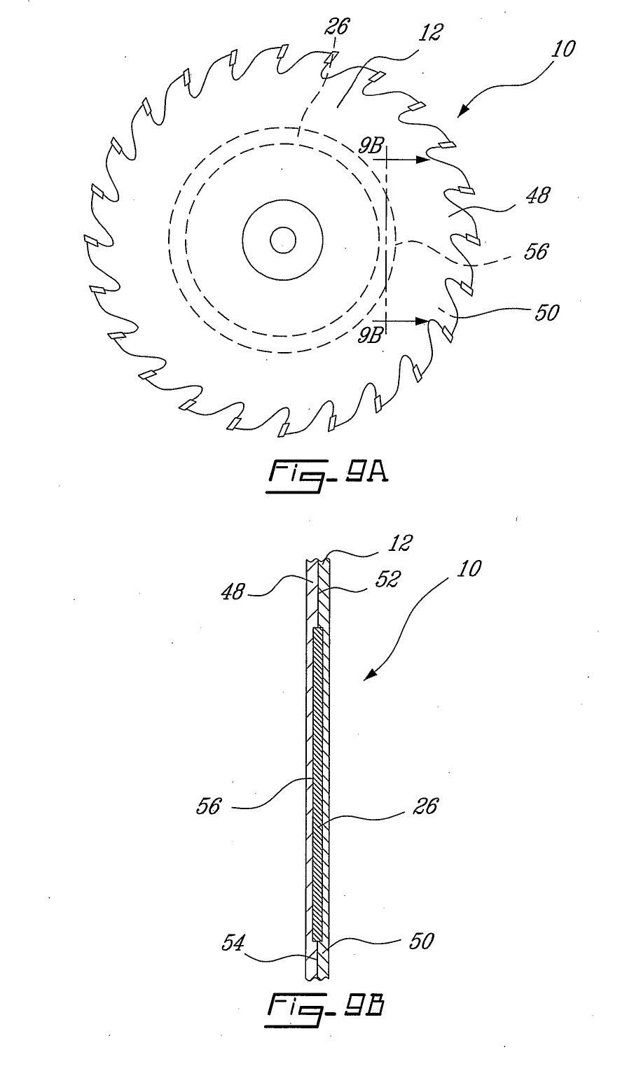

Referring now to FIGS. 8A and 8B, in a third alternative illustrative embodiment a series of openings 44 are machined or otherwise formed in the disk portion 12 of the disk/blade 10 between a first surface 46 and a second surface 48 and the inserts 26 inserted into the openings 44 and retained therein, illustratively through a combination of accurate machining and press fitting.

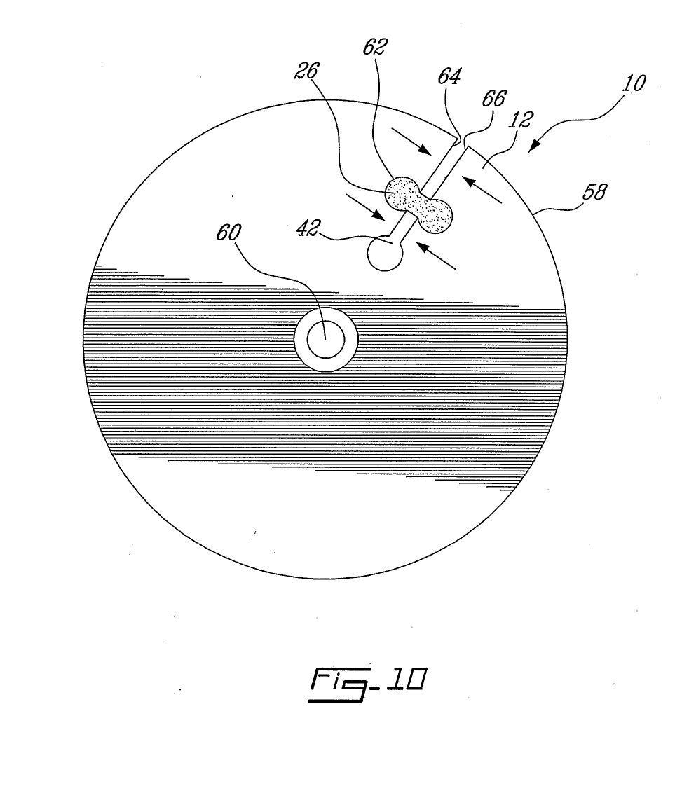

Referring to FIGS. 9A and 9B, in a forth alternative embodiment, the disk/blade 10 could be formed, for example, from two disks 48, 50 with suitably machined inner surfaces 52, 54 such that when both disks 48, 50 are bonded together, one or more cavities/openings 56 are formed. By positioning the insert(s) on the machined inner surfaces 52, 54 prior to bonding, a disk assembly can be arrived at where the insert(s) 26 are not exposed, which may have advantages in certain applications, for example where the disk blade is obliged to operate in environments which would otherwise adversely affect the insert(s) 26.

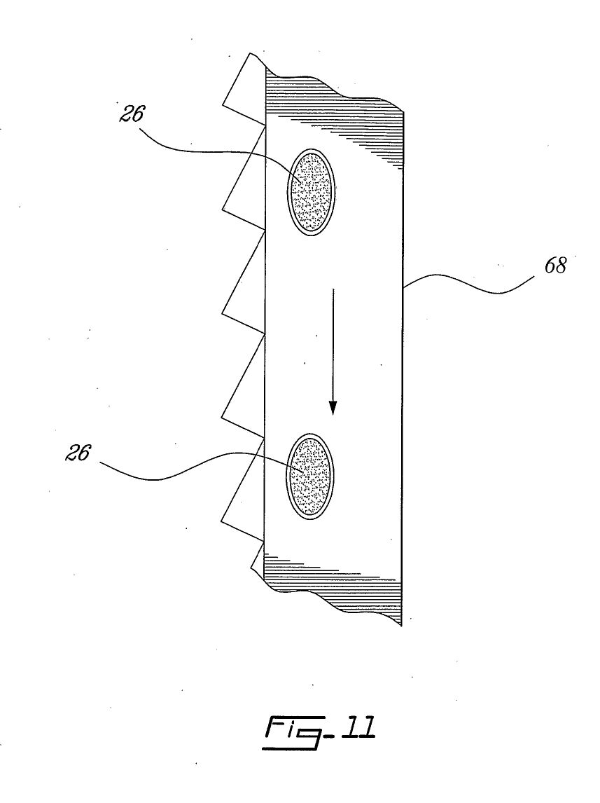

Referring now to FIG. 10, in a fifth alternative embodiment, similar to the embodiment disclosed in reference to FIGS. 6A and 6B, a series of slits as in 42, for example extending radially from the outer edge 58 towards an axis of rotation 60 of the disk/blade 10, are machined in the disk portion 12 of the blade 10. Additionally, a suitable opening 62 is machined in the region of each of the slits 42. A suitable insert as in 26 is inserted in the opening and retained therein, illustratively through a combination of accurate machining and press fitting. As will be now apparent to a person of ordinary skill in the art, provided the opening(s) 62 and insert(s) 26 are such that the insert does not move significantly when contracting, any contraction of the inserts 26 when in the austenite phase results in a force being brought to bear on the opening 62 which in turn causes the distance (gap) between the inside faces 64, 66 of the slit 42 to be reduced, thereby reducing the hoop stresses introduced by the peripheral heating.

Referring now to FIG. 11, a sixth alternative illustrative embodiment of the present invention is presented. Although the present invention has been described hereinabove in reference to a circular saw blade, similar phenomena arise in band saw blades 68 which in turn can be counteracted by a similar application of the inserts 26 as described hereinabove. Additionally, although the present invention has been described in reference to saw blades, the present invention may also be applied to other types of rotating disks where a temperature gradient between the centre of the disk and its periphery is present, for example for use in refiner plates used in a thermo-mechanical pulping and for stock preparation.

Although the present invention has been described hereinabove by way of illustrative embodiments thereof, these embodiments can be modified at will without departing from the spirit and nature of the subject invention.

1. A method for increasing the critical speed of a rotating disk, the method comprising the steps of:
providing a disk; and
fastening at least one heat sensitive insert to said disk, said at least one insert exerting a tensile stress on said disk when an insert temperature exceeds a predetermined temperature.

2. The method of claim 1, wherein said disk temperature increases from a disk centre towards a disk periphery, said insert is fastened towards said disk periphery and said exerted tensile stress is opposite to tensile stresses induced in said disk by said increasing temperature and rotation.

3. The method of claim 1, wherein said exerted tensile stress increases linearly with said temperature until a maximum exerted tensile stress is reached.

4. The method of claim 1, wherein said exerted tensile stress increases with a periphery temperature until a maximum exerted tensile stress is reached.

5. The method of claim 1, wherein said insert is fabricated from a Shape Memory Alloy (SMA).

6. The method of claim 5, wherein said SMA is a Nickel-Titanium (Ni—Ti) alloy.

6. The method of claim 5, wherein said SMA is a Nickel-Titanium (Ni—Ti) alloy.

7. The method of claim 5, wherein said SMA has a temperature of austenite phase onset (T_{As}) equal to said predetermined temperature.

8. The method of claim 1, wherein said predetermined temperature is about 30° C.

9. The method of claim 1, wherein said disk comprises, for each of said at least one insert, an opening formed therein between a first disk surface and a second disk surface, said opening adapted to receive said at least one insert therein, and wherein said fastening step comprises inserting said at least one insert in said opening.

10. The method of claim 9, wherein said disk is manufactured from a metal alloy, and said opening is machined in said disk.

11. The method of claim 10, wherein said at least one insert is press fit in said opening.

12. The method of claim 9, wherein said disk comprises a plurality of said openings arranged along a circle concentric with an axis of rotation of said disk, and wherein said fastening step comprises inserting one of said at least one insert in each of said openings.

13. The method of claim 12, wherein said openings are evenly spaced along said circle about said axis of rotation.

14. The method of claim 1, wherein said fastening step comprises attaching a first of said at least one insert to a first surface of said disk.

15. The method of claim 14, wherein said fastening step comprises attaching a second of said at least one insert to a second surface of said disk, wherein said second insert is positioned opposite said first insert.

16. The method of claim 15, wherein said fastening step comprises attaching a first plurality of said at least one insert to said first surface and a second plurality of said at last one insert to said second surface and wherein said first plurality is arranged opposite said second plurality.

17. The method of claim 1, wherein said disk comprises a first surface having at least one depression therein, said at least one depression adapted to receive said at least one insert and wherein said fastening step comprises retaining said at least one insert in said at least one depression.

18. The method of claim 17, wherein said disk is made of a metal alloy and said at least one depression is machined in said first disk surface.

19. The method of claim 17, wherein said insert comprises an outer surface flush with said first disk surface.

20. The method of claim 18, wherein said retaining step comprises press fitting said at least one insert into said depression.

21. The method of claim 1, wherein said at least one insert forms an annulus, said annulus positioned concentric with an axis of rotation of said disk.

22. The method of claim 21, wherein said fastening step comprises attaching a plurality of said annular inserts to said disk, each of said annular inserts having a different radius.

23. The method of claim 1, wherein said disk further comprises saw teeth arranged around an outer edge thereof.

24. A disk having an increased critical speed of rotation, the disk comprising:
at least one temperature sensitive insert fastened to the disk, said at least one insert exerting a tensile stress on the disk when a temperature of said at least one insert exceeds a predetermined temperature.

25. The disk of claim 24, wherein said insert temperature is substantially the same as a disk temperature in a region of said insert.

26. The disk of claim 25, wherein said disk temperature increases from a disk centre towards a disk periphery, said at least one insert is attached towards said disk periphery and said exerted tensile stress is opposite to tensile stresses induced in the disk by said increasing temperature and speed of rotation.

27. The disk of claim 24, wherein said exerted tensile stress increases proportionally to said increasing temperature until a maximum exerted tensile stress is reached.

28. The disk of claim 27, wherein said exerted tensile stress increases proportionally to a temperature of a disk periphery until a maximum exerted tensile stress is reached.

29. The disk of claim 24, wherein said insert is fabricated from a Shape Memory Alloy (SMA).

30. The disk of claim 29, wherein said SMA is a Nickel-Titanium (Ni—Ti) alloy.

31. The disk of claim 29, wherein said SMA has a temperature of austenite phase onset (T_{As}) equal to said predetermined temperature.

32. The disk of claim 24, wherein said predetermined temperature is about 30° C.

33. The disk of claim 24, further comprising, for each of said at least one insert, an opening formed therein between a first disk surface and a second disk surface, said opening adapted to receive said at least one insert therein.

34. The disk of claim 33, wherein the disk is manufactured from a metal alloy, and said opening is machined in the disk.

35. The disk of claim 34, wherein said at least one insert is press fit in said opening.

36. The disk of claim 33, wherein said disk comprises a plurality of said openings arranged along a circle concentric with an axis of rotation of the disk.

37. The disk of claim 36, wherein said openings are evenly spaced along said circle about said axis of rotation.

38. The disk of claim 24, wherein said at least one insert is fastened to a first surface of the disk.

39. The disk of claim 38, wherein a second of said at least one insert is fastened to a second surface of the disk, said second insert positioned opposite said first insert.

40. The disk of claim 39, further comprising a first plurality of said at least one insert fastened to said first surface and a second plurality of said at last one insert fastened to said second surface and wherein said second plurality is arranged opposite said first plurality.

41. The disk of claim 40, wherein said first plurality is arranged along a circle concentric with an axis of rotation of the disk.

42. The disk of claim 41, wherein said first plurality is evenly spaced along said circle.

43. The disk of claim 42, wherein the disk comprises a surface having at least one depression formed therein, said at least one depression adapted to receive said at least one insert therein.

44. The disk of claim 43, wherein the disk is made of a metal alloy and said at least one depression is machined in said disk surface.

45. The disk of claim 44, wherein said insert is fastened to said disk by press fitting said insert in said machined depression.

46. The disk of claim 24, wherein said at least one insert forms an annulus, said annulus positioned concentric with an axis of rotation of the disk.

47. The disk of claim 43, wherein said insert comprises an outer surface flush with said disk surface.

48. The disk of claim 46, comprising a plurality of said annular inserts fastened to said disk, each of said annular inserts having a different radius.

49. The disk of claim 43, further comprising a second surface having at least one depression formed therein and a plurality of said insert, said at least one depression adapted to retain at least one of said inserts therein.

50. The disk of claim 24, further comprising a series of teeth dispersed around a perimeter thereof, said teeth adapted for cutting a wood work piece.

51. A disk having an increased critical speed of rotation, the disk comprising:
a plurality of spaced slits machined in a periphery of the disk, each of said slits comprising a pair of opposed slit edges extending from said disk periphery towards a disk axis of rotation; and
for each of said slits, a temperature sensitive insert fastened to the disk and spanning said slit;
wherein when an insert temperature exceeds a predetermined temperature, said insert contracts thereby reducing a distance between said pair of opposed slit edges.

52. The disk of claim 51, wherein said slit edges extend generally radially from said disk periphery towards a disk axis of rotation.

53. The disk of claim 51, further comprising for each of said slits, a depression formed in a disk surface, said depression adapted to receive said insert therein.

54. The disk of claim 53, wherein the disk is made of a metal alloy and said depressions are machined in said disk surface.

55. The disk of claim 53, wherein said insert is flush with said disk surface.

56. The disk of claim 51, wherein said inserts are bonded to a disk surface.

57. The disk of claim 51, wherein said inserts are fastened to a disk surface using rivets.

58. The disk of claim 51, wherein said inserts are fabricated from a Shape Memory Alloy (SMA).

59. The disk of claim 58, wherein said SMA is a Nickel-Titanium (Ni—Ti) alloy.

60. The disk of claim 58, wherein said SMA has a temperature of austenite phase onset (T_{As}) equal to said predetermined temperature.

61. The disk of claim 51, wherein said predetermined temperature is about 30° C.

62. A method for reducing the kerf of a saw blade at high speeds, the blade having a serrated edge and a blade temperature which varies in relation to the distance from the teeth, the method comprising the steps of:
providing a blade; and
attaching at least one insert to said blade, said at least one insert exerting a tensile stress on said blade when a temperature of said at least one insert reaches a predetermined temperature, said exerted tensile stress opposite to a tensile stress induced in said blade by the varying blade temperature.

63. The method of claim 62, wherein said insert temperature is substantially the same as said blade temperature in a region of said insert.

64. The method of claim 62, wherein said blade is a band saw blade and said blade temperature decreases as a function of a distance from the serrated edge, said insert is attached towards the serrated edge and said exerted tensile stresses are opposite to those induced in said blade by said blade temperature and rotation.

65. The method of claim 62, wherein said blade is a rotating circular blade and said blade temperature decreases from the serrated edge towards a blade axis of rotation, said insert is attached towards a periphery of said blade and said exerted tensile stresses are opposite to those induced in said blade by said blade temperature and rotation.

66. The method of claim 62, wherein said blade comprises a surface having at least one depression therein, said at least one depression adapted to receive said at least one insert therein.

67. The method of claim 66, wherein said blade is fabricated from a metal alloy and said at least one depression is machined in said blade surface.

68. The method of claim 66, wherein said insert comprises an outer surface flush with said blade surface.

69. The method of claim 67, wherein said insert is fastened to said blade by press fitting said insert in said depression.

70. The method of claim 62, wherein said tensile stress increases linearly with said temperature until a maximum tensile stress is reached.

71. The method of claim 65, wherein said tensile stress increases with said periphery temperature until a maximum tensile stress is reached.

72. The method of claim 62, wherein said insert is fabricated from a Shape Memory Alloy (SMA).

73. The method of claim 72, wherein said SMA is a Nickel-Titanium (Ni—Ti) alloy.

74. The method of claim 72, wherein said SMA has a temperature of austenite phase onset (T_{As}) equal to said predetermined temperature.

75. The method of claim 62, wherein said predetermined temperature is about 30° C.

76. The method of claim 62, wherein said blade comprises, for each of said at least one insert, an opening formed therein between a first blade surface and a second blade surface, said opening adapted to receive said at least one insert therein, and wherein said attaching step comprises inserting said at least one insert in said opening.

77. The method of claim 76, wherein said blade is manufactured from a metal alloy, and said opening is machined in said blade.

78. The method of claim 77, wherein said at least one insert is press fit in said opening.

79. The method of claim 76, wherein said blade comprises a plurality of said openings arranged along a line generally parallel to the serrated edge, and wherein said attaching step comprises inserting one of said at least one insert in each of said openings.

80. The method of claim 79, wherein said openings are evenly spaced along said line.

81. A saw blade having a reduced kerf at high speeds, the blade having a serrated cutting edge, the blade comprising:
at least one insert attached to the blade, said at least one insert exerting a tensile stress on the blade when an insert temperature reaches a predetermined temperature, said exerted tensile stress opposite to stress induced by the blade temperature.

82. The blade of claim 81, wherein when operated the blade has a temperature which varies in relation to a distance from the serrated cutting edge and said insert temperature is substantially the same as said blade temperature in a region of said insert.

83. The blade of claim 81, wherein the blade is a band saw blade and a blade temperature decreases as a function of a distance from the serrated cutting edge, said insert is attached towards the teeth and said exerted tensile stresses are opposite to those induced in said blade by said blade temperature and rotation.

84. The blade of claim 81, wherein the blade is a rotating circular blade and a blade temperature decreases from the serrated cutting edge towards a blade axis of rotation, said insert is attached towards a periphery of said blade and said exerted tensile stresses are opposite to those induced in said blade by said blade temperature and rotation.

85. The blade of claim 81, wherein said blade comprises a surface having at least one depression therein, said at least one depression adapted to receive said at least one insert therein.

86. The blade of claim 85, wherein said blade is fabricated from a metal alloy and said at least one depression is machined in said blade surface.

87. The blade of claim 85, wherein said insert comprises an outer surface flush with said blade surface.

88. The blade of claim 86, wherein said insert is fastened to said blade by press fitting said insert in said depression.

89. The blade of claim 81, wherein said tensile stress increases linearly with said insert temperature until a maximum tensile stress is reached.

90. The blade of claim 81, wherein said insert is fabricated from a Shape Memory Alloy (SMA).

91. The blade of claim 90, wherein said SMA is a Nickel-Titanium (Ni—Ti) alloy.

92. The blade of claim 90, wherein said SMA has a temperature of austenite phase onset (T_{As}) equal to said predetermined temperature.

93. The blade of claim 81, wherein said predetermined temperature is about 30° C.

94. The blade of claim 81, wherein said blade comprises, for each of said at least one insert, an opening formed therein between a first blade surface and a second blade surface, said opening adapted to receive said at least one insert therein, and wherein said attaching step comprises inserting said at least one insert in said opening.

95. The blade of claim 94, wherein said blade is manufactured from a metal alloy, and said opening is machined in said blade.

96. The blade of claim 95, wherein said at least one insert is press fit in said opening.

97. The blade of claim 94, wherein said blade comprises a plurality of said openings arranged along a line generally parallel to the serrated edge, and wherein said attaching step comprises inserting one of said at least one insert in each of said openings.

98. The blade of claim 97, wherein said openings are evenly spaced along said line.
